(19) United States
(12) Patent Application Publication
(10) Pub. No.: US 2026/0112796 A1
(43) Pub. Date: Apr. 23, 2026

(54) BATTERY PACK INTERCONNECT ASSEMBLY FOR A BATTERY PACK

(71) Applicant: TE Connectivity Solutions GmbH, Schaffhausen (CH)

(72) Inventors: Evan DAWLEY, Troy, MI (US); Andre Martin DRESSEL, Bensheim (DE)

(21) Appl. No.: 19/213,288

(22) Filed: May 20, 2025

Related U.S. Application Data
(60) Provisional application No. 63/709,703, filed on Oct. 21, 2024.

(51) Int. Cl. H01M 50/569; H01M 50/209; H01M 50/507; H01M 50/516

(52) U.S. Cl. CPC H01M 50/569; H01M 50/507; H01M 50/516; H01M 50/209

(57) ABSTRACT

A battery pack interconnect assembly for electrically connecting cell terminals of battery cells in a battery pack includes a busbar interconnect with busbars arranged in rows and columns and a busbar carrier holding the busbars. Each busbar includes mating ends for mating with the corresponding cell terminals. The battery pack interconnect assembly includes a sensing harness having sensing points coupled to the busbars. The sensing harness includes busbar sensing cables and connecting cables coupled to each of the busbar sensing cables. The cables are flat flexible cables having flat conductors electrically connected to the corresponding busbars to sense a voltage of each of the corresponding busbars.

### CROSS REFERENCE TO RELATED APPLICATIONS

This application claims benefit to U.S. Application No. 63/709,703, filed 21 Oct. 2024, the subject matter of which is herein incorporated by reference in its entirety.

### BACKGROUND OF THE INVENTION

The subject matter herein relates generally to battery packs, such as battery packs for electric vehicles.

Electric vehicles include a battery system including a battery pack having a large number of battery cells. A typical battery system requires a connectivity solution to transfer/distribute power between groups of battery cells and have provisions for sensing battery parameters like voltage and temperature. To transfer power, busbars (aluminum or copper) are usually welded to the cell terminals in serial and/or parallel electrical configuration. As electric vehicle applications proliferate, the overhead cost of components ($/kWh) is scrutinized and there is a desire to minimize costs, such as by minimizing the part count and part numbers. For battery systems of electric vehicles, the battery cell stack sizes are very large. Typically, assembly of the battery system requires many parts, which are individually assembled to the corresponding cell terminals, which is time consuming and adds cost to the assembly process. There is a need to monitor operating parameters of the components, such as voltages at each of the busbars, temperature, charge state, or other operating characteristics. Some systems use wire harnesses with sensors to monitor the components of the battery system. The wire harnesses add weight, cost, and assembly time.

A need remains for a method for assembling battery packs, such as for electric vehicles, in a cost effective and reliable manner.

### BRIEF DESCRIPTION OF THE INVENTION

In one embodiment, a battery pack interconnect assembly for electrically connecting cell terminals of battery cells in a battery pack is provided. The battery pack interconnect assembly includes a busbar interconnect which includes a plurality of busbars arranged in a matrix having multiple rows of the busbars and multiple columns of the busbars and a busbar carrier holding the busbars. Each busbar includes a first mating end for mating with the corresponding cell terminal of the corresponding battery cell and a second mating end for mating with the adjacent cell terminal of the adjacent corresponding battery cell. The busbars electrically connect the battery cells in the battery pack. The battery pack interconnect assembly includes a sensing harness having sensing points coupled to the busbars. The sensing harness includes busbar sensing cables and connecting cables coupled to each of the busbar sensing cables. The busbar sensing cables are flat flexible cables having a plurality of sensing flat conductors. The connecting cables are flat flexible cables having a plurality of connecting flat conductors. The busbar sensing cables extend along the columns of the busbars with the sensing flat conductors electrically connected to the corresponding busbars in the corresponding column at the corresponding sensing points to sense a voltage of each of the corresponding busbars. The connecting cables span each of the busbar sensing cables with the connecting flat conductors electrically connected to the corresponding sensing flat conductors of each of the busbar sensing cables. The connecting flat conductors of the connecting cables are electrically connected to a control module.

In another embodiment, a sensing harness for sensing voltages of busbars electrically connected to cell terminals of battery cells in a battery pack is provided. The sensing harness includes busbar sensing cables that extend parallel to each other in columns. The busbar sensing cables are flat flexible cables having a plurality of sensing flat conductors. The busbar sensing cables extend along columns of the busbars. The sensing flat conductors configured to be electrically connected to the corresponding busbars in the corresponding column at sensing points to sense a voltage of each of the corresponding busbars. The sensing harness includes connecting cables that extend parallel to each other in rows. The connecting cables are flat flexible cables having a plurality of connecting flat conductors. The connecting cables span each of the busbar sensing cables. The connecting flat conductors are electrically connected to the corresponding sensing flat conductors of each of the busbar sensing cables. The connecting flat conductors of the connecting cables are electrically connected to a control module.

In a further embodiment, a battery pack is provided and includes battery cells arranged in a matrix having multiple rows and multiple columns of the battery cells. Each battery cell includes a first cell terminal and a second cell terminal. The battery pack includes a battery pack interconnect assembly electrically connected to the first and second cell terminals of the battery cells. The battery pack interconnect assembly includes a busbar interconnect and a sensing harness electrically connected to the busbar interconnect. The busbar interconnect includes a plurality of busbars arranged in a matrix having multiple rows of the busbars and multiple columns of the busbars and a busbar carrier holding the busbars. Each busbar includes a first mating end for mating with the first cell terminal of the corresponding battery cell and a second mating end for mating with the second cell terminal of the adjacent corresponding battery cell. The busbars electrically connect the battery cells in the battery pack. The sensing harness has sensing points coupled to the busbars. The sensing harness includes busbar sensing cables and connecting cables. The busbar sensing cables are flat flexible cables having a plurality of sensing flat conductors. The connecting cables are flat flexible cables having a plurality of connecting flat conductors. The busbar sensing cables extend along the columns of the busbars with the sensing flat conductors electrically connected to the corresponding busbars in the corresponding column at the corresponding sensing points to sense a voltage of each of the corresponding busbars. The connecting cables span each of the busbar sensing cables with the connecting flat conductors electrically connected to the corresponding sensing flat conductors of each of the busbar sensing cables. The connecting flat conductors of the connecting cables are electrically connected to a control module.

### BRIEF DESCRIPTION OF THE DRAWINGS

FIG. 1 is a perspective view of a battery pack including a battery pack interconnect assembly in accordance with an exemplary embodiment.

FIG. 2 is a top view of the battery pack interconnect assembly in accordance with an exemplary embodiment.

FIG. 3 is a top view of the busbar sensing cable in accordance with an exemplary embodiment.

FIG. 4 is an enlarged view of a portion of the busbar sensing cable in accordance with an exemplary embodiment.

FIG. 5 is a cross-sectional view of the busbar sensing cable in accordance with an exemplary embodiment.

FIG. 6 is a cross-sectional view of the busbar sensing cable at another location in accordance with an exemplary embodiment.

FIG. 7 is a top view of the busbar sensing cable in accordance with an exemplary embodiment.

FIG. 8 is a cross-sectional view of the busbar sensing cable in accordance with an exemplary embodiment.

FIG. 9 is a top view of the connecting cable in accordance with an exemplary embodiment.

FIG. 10 is an enlarged view of a portion of the connecting cable in accordance with an exemplary embodiment.

FIG. 11 is an enlarged view of another portion of the connecting cable in accordance with an exemplary embodiment.

FIG. 12 is a cross-sectional view of the connecting cable in accordance with an exemplary embodiment.

FIG. 13 is a cross-sectional view of the connecting cable at another location in accordance with an exemplary embodiment.

FIG. 14 is an enlarged view of a portion of the battery pack interconnect assembly in accordance with an exemplary embodiment showing four rows and two columns of the busbars.

FIG. 15 is an enlarged view of a portion of the battery pack interconnect assembly in accordance with an exemplary embodiment showing two rows and two columns of the busbars.

### DETAILED DESCRIPTION OF THE INVENTION

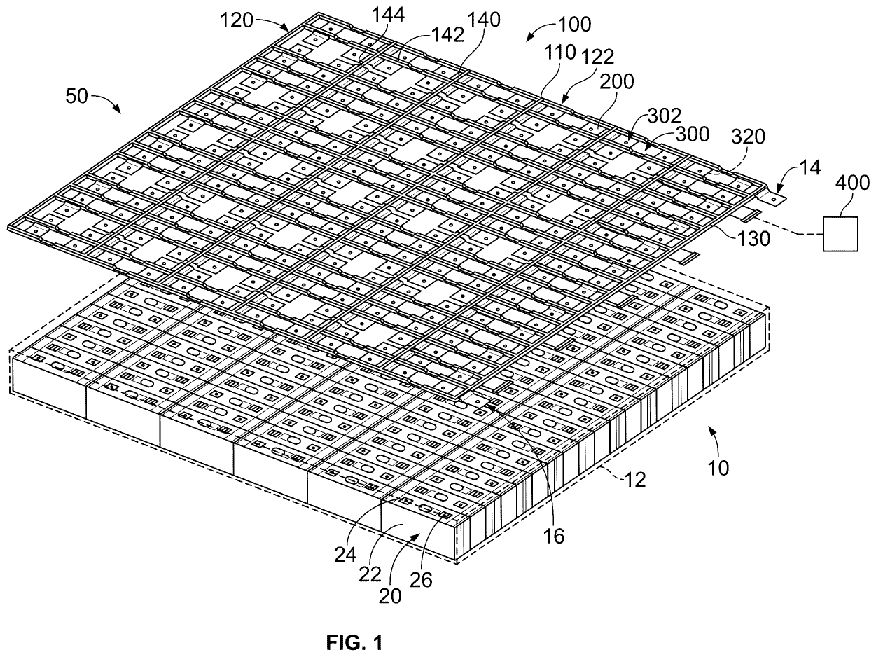

FIG. 1 is a perspective view of a battery pack 10 including a battery pack interconnect assembly 50 in accordance with an exemplary embodiment. The battery pack interconnect assembly 50 includes a busbar interconnect 100 having a plurality of busbars 200 and a sensing harness 300 for sensing parameters of the battery pack, such as voltage, temperature, charge state, or other operating characteristics of the battery pack 10.

The battery pack 10 may be a battery pack for a vehicle, such as an electric vehicle. However, the battery pack 10 may be used in other applications in alternative embodiments. In an exemplary embodiment, the battery pack 10 is a high voltage battery pack. For example, the battery pack 10 may be a 400V or 800V battery pack. The busbar interconnect 100 is used to electrically connect a matrix of battery cells 20 of the battery pack 10. For example, the busbar interconnect 100 may electrically connect the battery cells 20 in series and/or parallel.

The battery cells 20 may be held in a battery pack housing 12. The battery pack 10 includes a positive battery interconnect terminal 14 and a negative battery interconnect terminal 16. The battery interconnect terminals 14, 16 may interface to other power distribution components of the battery pack 10, such as contactors and fuses for connection to a charging system and/or a load, such as an electric motor.

Each battery cell 20 includes a cell housing 22, a first cell terminal 24, and a second cell terminal 26. The battery cell 20 may be a prismatic battery cell in various embodiments. The first and second cell terminals 24, 26 may be cathode and anode terminals. In an exemplary embodiment, the battery cell 20 are rectangular and arranged in a stacked configuration. For example, the battery cells 20 may be stacked in rows and columns of battery cells 20 in the matrix. The cell matrix may have a large surface area, such as greater than two square meters (2 m² or more). For example, the matrix may have a length of between approximately 1.0 m and 2.0 m and a width of between approximately 1.0 m and 1.5 m. Adjacent battery cells 20 in the rows are interconnected by the corresponding busbars 200 of the busbar interconnect 100. Adjacent rows of the battery cells 20 are interconnected by the corresponding busbars 200 of the busbar interconnect 100. For example, end battery cells 20 may be connected row-to-row.

The busbar interconnect 100 includes a busbar carrier 110 holding the busbars 200. The busbar carrier 110 holds the busbars 200 at relative locations for mating with the cell terminals 24, 26 of the corresponding battery cells 20. The busbars 200 electrically connect adjacent battery cells 20, such as in series and/or in parallel. In various embodiments, the busbar carrier 110 integrates all of the busbars 200 into a single unit or structure for mounting to the matrix of battery cells 20. For example, a single busbar carrier 110 may be used to hold all of the busbars 200. In other various embodiments, the busbar carrier 110 may include multiple frames or units, each holding a plurality of the busbars 200, such as a column of the busbars 200, the frames/units may be connected together by other elements of the busbar carrier 110 to form a connected structure.

In various embodiments, the busbar carrier 110 may be a structural foam leadframe that holds the busbars 200. For example, the busbar carrier 110 may be manufactured by a structural foam molding process. The busbar carrier may be manufactured from other materials in alternative embodiments, such as a molded plastic structure. The busbar carrier 110 may be molded or formed on the busbar matrix. For example, the busbar carrier 110 may be overmolded in situ over portions of the busbars 200 to form the busbar interconnect 100. The busbar carrier 110 may be formed around portions of the busbars 200 to hold the busbars 200 relative to each other and relative to the cell terminals 24, 26 of the battery cells 20.

In an exemplary embodiment, the busbar carrier 110 includes a framework or lattice 120. The lattice 120 is formed around portions of the busbars 200 to hold the busbars 200 at relative positions. In an exemplary embodiment, the busbar carrier 110 holds all of the busbars 200 for the battery pack 10 to reduce part count for final assembly to the battery pack 10. For example, the single busbar interconnect 100 is assembled to the battery pack 10. The busbar carrier 110 is used to position the busbars 200 for electrical connection to the cell terminals 24, 26 of the battery cells 20. In an exemplary embodiment, the sensing harness 300 is coupled to the busbar carrier 110. The busbar carrier 110 may be used to position the sensing harness on the battery cells 20.

The lattice 120 includes frame members 122 configured to be coupled to the busbars 200 to hold relative positions of the busbars 200. The frame members 122 include outer frame members 130 surrounding a perimeter of the lattice 120 and inner frame members 140 spanning across an interior of the lattice 120 to interface with the busbars 200. The inner frame members 140 extend between the outer frame members 130. For example, the inner frame members 140 include longitudinal elements 142 and lateral elements 144. The longitudinal elements 142 extend longitudinally across the lattice 120 between the opposite ends. The lateral elements 144 extend laterally across the lattice 120 between the opposite sides. The longitudinal elements 142 and/or the lateral elements 144 may be used to support portions of the busbars 200. The lateral elements 144 interconnect the longitudinal elements 142, such as to provide support to the longitudinal elements 142, and vice versa. In an exemplary embodiment, the inner frame members 140 are formed integral with the outer frame members 130. For example, the inner frame members 140 are formed along with the outer frame members 130 during a structural molding process. The lattice 120 forms a unitary, monolithic structure.

In an exemplary embodiment, the lateral elements 144 span across the columns of busbars 200. The lateral elements 144 engage the busbars 200 to support the busbars 200. The lateral elements 144 support each of the busbars 200 in the corresponding columns. In an exemplary embodiment, the longitudinal elements 142 are located in the gaps between the rows of the busbars 200. In the illustrated embodiment, the longitudinal elements 142 are not used to support the busbars 200. However, in alternative embodiments, the longitudinal elements 142 may additionally or alternatively be used to support some or all of the busbars 200.

In an exemplary embodiment, the sensing harness 300 has sensing points 302 for monitoring the busbars 200 and/or the cell terminals 24, 26. For example, the sensing harness 300 is electrically connected to the busbars 200 at the sensing points 302 to monitor voltage, temperature, charge state, or other operating characteristics of the busbars 200 and/or the cell terminals 24, 26. The sensing harness 300 is configured to be electrically connected to a control module 400, such as a battery control module. The sensing harness 300 sends sensing signals from the sensing points 302 to the control module 400, which may be used to control operation of the vehicle and/or a charging operation of the vehicle.

The battery pack interconnect assembly 50 provides a large format battery cell interconnect assembly that is configured to be mounted to the battery pack 10 (for example, each of the battery cells 20) as a single unit. The busbar carrier 110 holds all of the busbars 200 at proper locations for termination to the cell terminals 24, 26 of each of the battery cells 20 of the battery pack 10. By holding all of the busbars 200 for assembly to all of the battery cells 20 of the battery pack 10, assembly processes may be eliminated, such as with conventional battery systems where each of the busbars are assembled to the battery cells individually with multiple assembly steps. The busbar interconnect 100 reduces the overall part number count and reduces the number of handled components during assembly of the battery pack 10. The busbar carrier 110 may have a large format and surface area. For example, the structural process to manufacture the lattice framework for the busbar carrier 110 enables a large footprint for the busbar carrier 110. The structural material of the lattice framework for the busbar carrier 110 is dimensionally stable and does not tend to warp making assembly and termination to the battery cells more simple, quicker, and lower cost compared to conventional assembly processes.

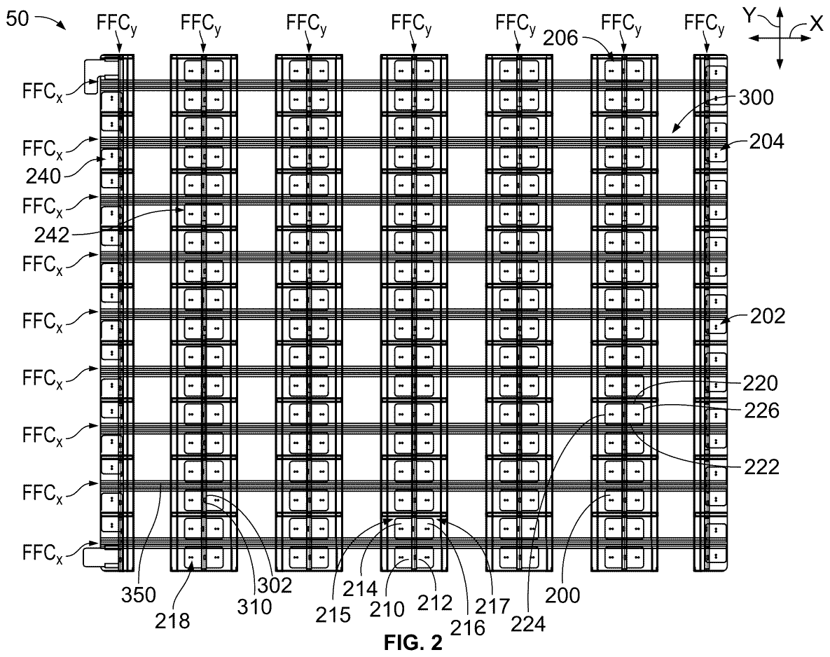

FIG. 2 is a top view of the battery pack interconnect assembly 50 in accordance with an exemplary embodiment. FIG. 2 illustrates a matrix 202 of the busbars 200 and the sensing harness 300 coupled to the busbars 200. The busbars 200 are arranged in rows 204 and columns 206 in the matrix 202. The arrangement of the busbars 200 corresponds to the arrangement of the battery cells 20 to connect to the corresponding cell terminals 24, 26. The sensing harness 300 traverses the rows 204 and columns 206 of the busbars 200 to electrically connect to each of the busbars 200 for sensing characteristics (for example, voltages) of each of the busbars 200.

Each busbar 200 includes a metal plate 210 having a main body 212, a first mating pad 214 at a first mating end 215, and a second mating pad 216 at a second mating end 217. The first mating pad 214 is configured to connect to a cell terminal 24 of one of the battery cells 20. The second mating pad 216 is configured to connect to a cell terminal 26 of an adjacent battery cell 20. The busbar 200 electrically connects the adjacent battery cells 20. The mating pads 214, 216 may include openings 218 therethrough, such as for locating the busbars 200 relative to the cell terminals 24, 26. The openings 218 may be used for a pick and place operation. The openings 218 may be used to hold positions of the busbars 200 during the overmolding process of forming the busbar carrier 110.

In an exemplary embodiment, each busbar 200 is generally rectangular. For example, the busbar 200 includes a first end 220, a second end 222, a first side 224, and a second side 226. The busbar 200 may be elongated, such as having the ends 220, 222 longer than the sides 224, 226. In an exemplary embodiment, the busbar is generally planar. For example, the first and second mating pads 214, 216 may be coplanar for attachment to the cell terminals 24, 26. Optionally, the main body 212 may be offset or out of plane relative to the first and second mating pads 214, 216, such as located above or below the plane of the first and second mating pads 214, 216. The busbar 200 may include mounting features, such as mounting tabs, posts, brackets, clips, notches, openings, and the like for mounting the busbar 200 to the busbar carrier 110.

In an exemplary embodiment, the matrix 202 of the busbars 200 include eighteen rows 204 of the busbars 200 and seven columns 206 of the busbars 200. Greater or fewer busbars 200 may be provided in the rows 204 and/or the columns 206 in alternative embodiments. In an exemplary embodiment, the busbars 200 include outer busbars 240 and inner busbars 242. The outer busbars 240 are arranged along the opposite sides of the busbar matrix 202 (for example, right side and left side). The outer busbars 240 are used to connect between two different rows of the battery cells 20. The inner busbars 242 extend between the outer busbars 240. The inner busbars 242 are used to connect the adjacent battery cells 20 within the same column. The outer busbars 240 are oriented perpendicular to the inner busbars 242. For example, the inner busbars 242 are oriented longitudinally and the outer busbars 240 are oriented laterally. Other orientations are possible in alternative embodiments.

The sensing harness 300 includes busbar sensing cables 310 and connecting cables 350 coupled to each of the busbar sensing cables 310. The busbar sensing cables 310 and the connecting cables 350 form a lattice structure that overlaps the matrix 202 of the busbars 200. For example, the busbar sensing cables 310 and the connecting cables 350 may be oriented perpendicular to each other. In the illustrated embodiment, the busbar sensing cables 310 extend in the Y direction and the connecting cables 350 extend in the X direction. In an exemplary embodiment, the busbar sensing cables 310 are flat flexible cables (FFC_{y}) having a plurality of flat conductors arranged in an insulator. In an exemplary embodiment, the connecting cables 350 are flat flexible cables (FFCₓ) having a plurality of flat conductors arranged in an insulator.

In an exemplary embodiment, the busbar sensing cables 310 extend along the columns 206 of the busbars 200 and are electrically connected to each of the busbars 200 in the corresponding column 206 at the corresponding sensing points 302 to sense characteristics, such as voltage, of each of the corresponding busbars 200. The connecting cables 350 span each of the busbar sensing cables 310 and are electrically connected to the busbar sensing cables 310 to aggregate the signals from the busbar sensing cables 310. The connecting cables 350 are electrically connected to the control module 400.

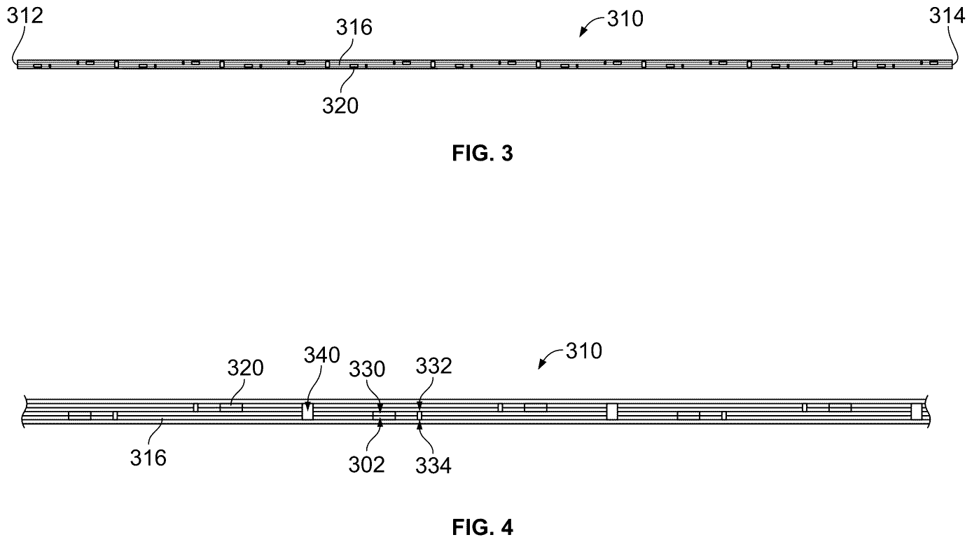

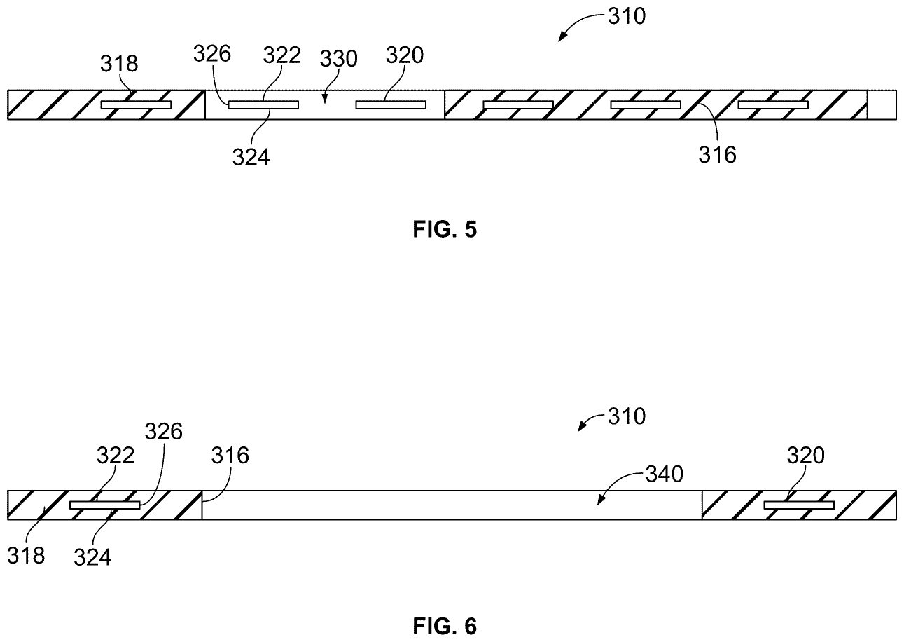

FIG. 3 is a top view of the busbar sensing cable 310 in accordance with an exemplary embodiment. FIG. 4 is an enlarged view of a portion of the busbar sensing cable 310 in accordance with an exemplary embodiment. FIG. 5 is a cross-sectional view of the busbar sensing cable 310 in accordance with an exemplary embodiment. FIG. 6 is a cross-sectional view of the busbar sensing cable 310 at another location in accordance with an exemplary embodiment.

In an exemplary embodiment, the busbar sensing cable 310 is a flat flexible cable. The busbar sensing cable 310 extends between a first end 312 and a second end 314. The busbar sensing cable 310 includes an insulator 316 holding a plurality of sensing flat conductors 320. The insulator 316 may include one or more layers of flexible plastic film 318, such as an upper film, a lower film, and may include one or more intermediate films between the upper and lower films. The layers may be connected by adhesive. The insulator 316 may be a laminated structure. In other various embodiments, the insulator 316 may be extruded around the sensing flat conductors 320. The sensing flat conductors 320 are sandwiched between layers of the flexible plastic film 318. The films 318 may be manufactured from a polyester-based material, polyethylene-based material, polyamide-based material, polyurethane-based material material, PVC material, and the like. The films 318 may be laminated to each other and/or to the sensing flat conductors 320, such as using one or more adhesive layers, to form a single, flexible unit.

The sensing flat conductors 320 are flat, parallel conductors. The sensing flat conductors 320 may be copper, aluminum, or other metal material. Each sensing flat conductor 320 includes an upper surface 322 and a lower surface 324. The sensing flat conductor 320 includes sides 326 between the upper and lower surfaces 322, 324. In an exemplary embodiment, the sensing flat conductors 320 have a rectangular cross-section. The films 318 cover the upper and lower surfaces 322, 324. The films 318 may be located between the sides 326 of the adjacent sensing flat conductors 320.

In the illustrated embodiment, the busbar sensing cable 310 includes six of the sensing flat conductors 320. The busbar sensing cable 310 may include greater or fewer sensing flat conductors 320 in alternative embodiments. In an exemplary embodiment, the sensing flat conductors 320 each have the same size (for example, height and width). However, in alternative embodiments, the sensing flat conductors 320 may have different sizes. In an exemplary embodiment, the busbar sensing cable 310 may have a common pitch or spacing between the sensing flat conductors 320. However, in alternative embodiments, the busbar sensing cable 310 may have different pitches between the sensing flat conductors 320.

In an exemplary embodiment, the busbar sensing cable 310 includes sensing access windows 330 (FIG. 5) exposing the corresponding sensing flat conductors 320 at the sensing points 302. For example, portions of the insulator 316 may be selectively removed to form the sensing access windows 330 and expose the sensing flat conductors 320. In various embodiments, the insulator 316 may be removed by ablation, skiving, cutting, or other removal processes. The sensing access windows 330 provide access to the sensing flat conductors 320 at the sensing points 302 for electrical connection of the sensing flat conductors 320 to the busbars 200. For example, the sensing flat conductors 320 may be electrically connected to the corresponding busbars 200 by one of a welded connection, a conductive bonding connection, a staking connection, or a conductive adhesive connection.

In an exemplary embodiment, multiple sensing flat conductors 320 may be exposed in each of the sensing access windows 330. Exposing multiple sensing flat conductors 320 in each sensing access window 330 allows multiple points of contact between the busbar sensing cable 310 and the corresponding busbars 200. The redundant electrical connection of multiple sensing flat conductors 320 to the corresponding busbar 200 improves reliability and/or limits warranty cost, recalls, and scrapping of materials.

In an exemplary embodiment, the busbar sensing cable 310 includes connecting access windows 332 exposing the corresponding sensing flat conductors 320 at joining points 334. For example, portions of the insulator 316 may be selectively removed to form the connecting access windows 332 and expose the sensing flat conductors 320. In various embodiments, the insulator 316 may be removed by ablation, skiving, cutting, or other removal processes. The connecting access windows 332 provide access to the sensing flat conductors 320 at the joining points 334 for electrical connection of the sensing flat conductors 320 to the connecting cables 350. For example, the sensing flat conductors 320 may be electrically connected to the corresponding connecting flat conductors of the connecting cables 350 by one of a welded connection, a conductive bonding connection, a staking connection, or a conductive adhesive connection.

In an exemplary embodiment, the busbar sensing cable 310 includes conductor separating windows 340 (FIG. 6) through the busbar sensing cable 310. For example, portions of the insulator 316 and portions of the sensing flat conductors 320 may be selectively removed to form the conductor separating windows 330. In various embodiments, the conductor separating windows 340 are formed by cutting, punching, ablating or other removal processes for removing the insulator 316 and portions of the sensing flat conductors 320. Such removal allows separating the sensing flat conductors 320 into electrically isolated segments. Electrically isolating the segments of the sensing flat conductors 320 allows connection of the same sensing flat conductors 320 to the different busbars 200 without short-circuiting or damaging the sensing flat conductors 320.

In an exemplary embodiment, some of the sensing flat conductors 320 are not removed, but rather pass along the sides of the conductor separating windows 340. For example, the outer most sensing flat conductors 320 may remain intact along the length of the busbar sensing cable 310 and only the inner sensing flat conductors 320 are removed at the conductor separating windows 340. Such sensing flat conductors 320 may be used to provide structural cohesion of the busbar sensing cable 310 along the length of the busbar sensing cable 310 such that the sensing cable 310 remains as a single or unitary part. For example, such sensing flat conductors 320 are not used as sensing conductors and are not electrically connected to any of the busbars 200. For example, such sensing flat conductors 320 are not exposed in any of the sensing access windows 330.

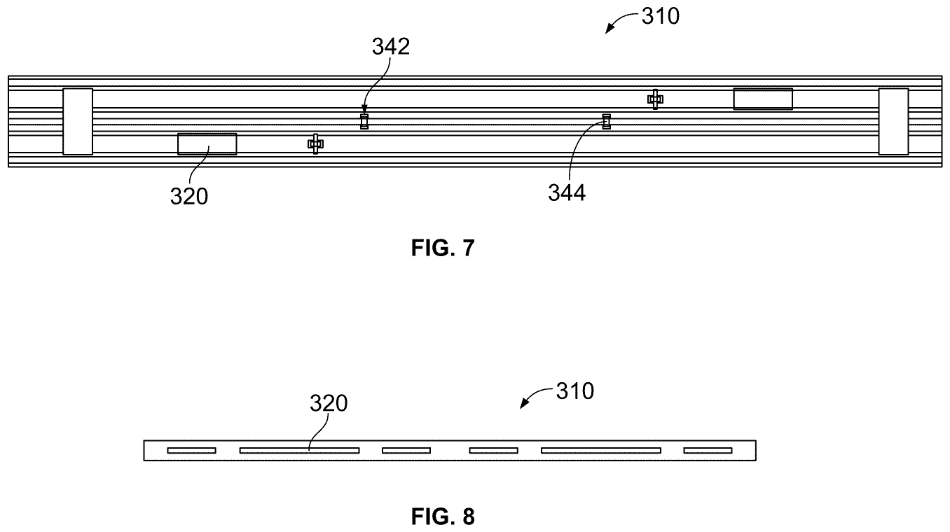

FIG. 7 is a top view of the busbar sensing cable 310 in accordance with an exemplary embodiment. FIG. 8 is a cross-sectional view of the busbar sensing cable 310 in accordance with an exemplary embodiment. FIGS. 7 and 8 show the busbar sensing cable 310 having different sized sensing flat conductors 320. For example, two of the sensing flat conductors 320 used for connection to the busbars 200 for sensing parameters of the busbars 200 are wider than the other sensing flat conductors 320. The two wide sensing flat conductors 320 may be at least twice as wide as the other sensing flat conductors 320.

In an exemplary embodiment, the busbar sensing cable 310 may include other mounting locations 342, such as for mounting of other sensors or components 344, such as temperature sensors, fuses, or other components. The components 344 may be electrically connected to one or more of the sensing flat conductors 320.

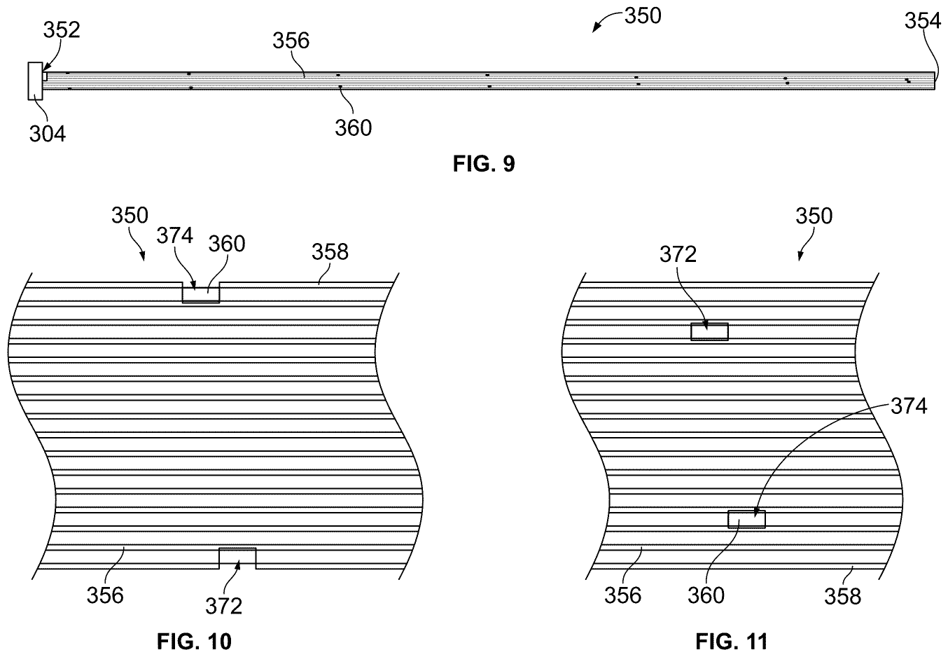

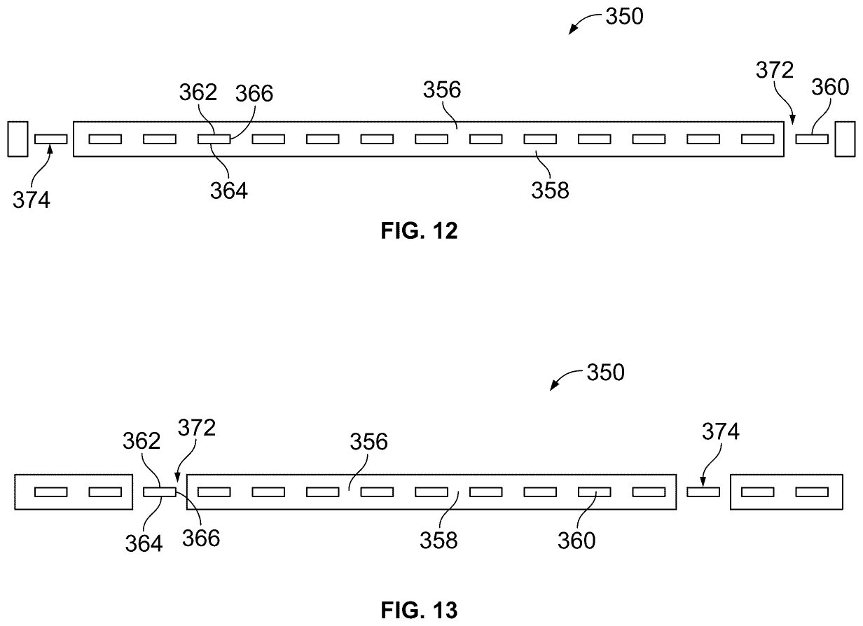

FIG. 9 is a top view of the connecting cable 350 in accordance with an exemplary embodiment. FIG. 10 is an enlarged view of a portion of the connecting cable 350 in accordance with an exemplary embodiment. FIG. 11 is an enlarged view of another portion of the connecting cable 350 in accordance with an exemplary embodiment. FIG. 12 is a cross-sectional view of the connecting cable 350 in accordance with an exemplary embodiment. FIG. 13 is a cross-sectional view of the connecting cable 350 at another location in accordance with an exemplary embodiment.

In an exemplary embodiment, the connecting cable 350 is a flat flexible cable. The connecting cable 350 extends between a first end 352 and a second end 354. In an exemplary embodiment, an electrical connector 304 is provided at the first end 352. The electrical connector 304 is configured to be electrically connected to the control module 400.

The connecting cable 350 includes an insulator 356 holding a plurality of connecting flat conductors 360. The insulator 356 may include one or more layers of flexible plastic film 358, such as an upper film, a lower film, and may include one or more intermediate films between the upper and lower films. The layers may be connected by adhesive. The insulator 356 may be a laminated structure. In other various embodiments, the insulator 356 may be extruded around the connecting flat conductors 360. The connecting flat conductors 360 are sandwiched between layers of the flexible plastic film 358. The films 358 may be manufactured from a polyester-based material, polyethylene-based material, polyamide-based material, polyurethane-based material material, PVC material, and the like. The films 358 may be laminated to each other and/or to the connecting flat conductors 360, such as using one or more adhesive layers, to form a single, flexible unit.

The connecting flat conductors 360 are flat, parallel conductors. The connecting flat conductors 360 may be copper, aluminum, or other metal material. Each sensing flat conductor 360 includes an upper surface 362 and a lower surface 364. The sensing flat conductor 360 includes sides 366 between the upper and lower surfaces 362, 364. In an exemplary embodiment, the connecting flat conductors 360 have a rectangular cross-section. The films 358 cover the upper and lower surfaces 362, 364. The films 358 may be located between the sides 366 of the adjacent connecting flat conductors 360.

In the illustrated embodiment, the connecting cable 350 includes fifteen of the connecting flat conductors 360. The connecting cable 350 may include greater or fewer connecting flat conductors 360 in alternative embodiments, such as to accommodate the number of busbar voltage signals, or other components such as temperature sensors, to be measured, which may be dependent on the number of battery cells. In an exemplary embodiment, the connecting flat conductors 360 each have the same size (for example, height and width). However, in alternative embodiments, the connecting flat conductors 360 may have different sizes. In an exemplary embodiment, the connecting cable 350 may have a common pitch or spacing between the connecting flat conductors 360. However, in alternative embodiments, the connecting cable 350 may have different pitches between the connecting flat conductors 360.

In an exemplary embodiment, the connecting cable 350 includes connecting access windows 372 exposing the corresponding connecting flat conductors 360 at joining points 374. For example, portions of the insulator 356 may be selectively removed to form the connecting access windows 372 and expose the connecting flat conductors 360. In various embodiments, the insulator 356 may be removed by ablation, skiving, cutting, or other removal processes. The connecting access windows 372 provide access to the connecting flat conductors 360 at the joining points 374 for electrical connection to the sensing flat conductors 320 of the busbar sensing cables 310. For example, the connecting flat conductors 360 may be electrically connected to the corresponding sensing flat conductors 320 by one of a welded connection, a conductive bonding connection, a staking connection, or a conductive adhesive connection. In an exemplary embodiment, the connecting access windows 374 expose different connecting flat conductors 360 along different segments of the connecting cable 350 for connection to different busbar sensing cables 310. For example, each connecting flat conductor 360 may be exposed at a different location along the length of the connecting cable 350 for connection to a different busbar sensing cable 310.

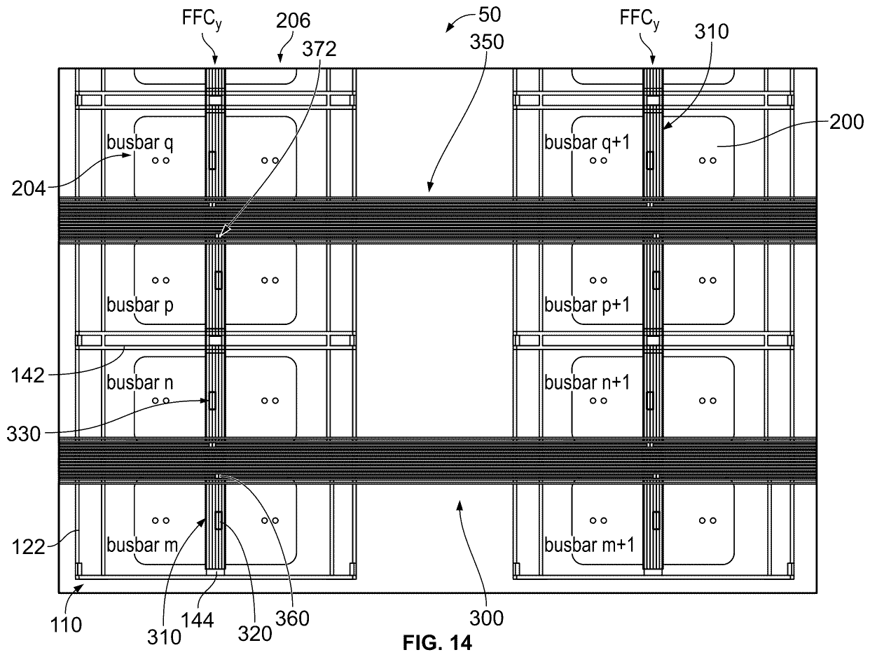

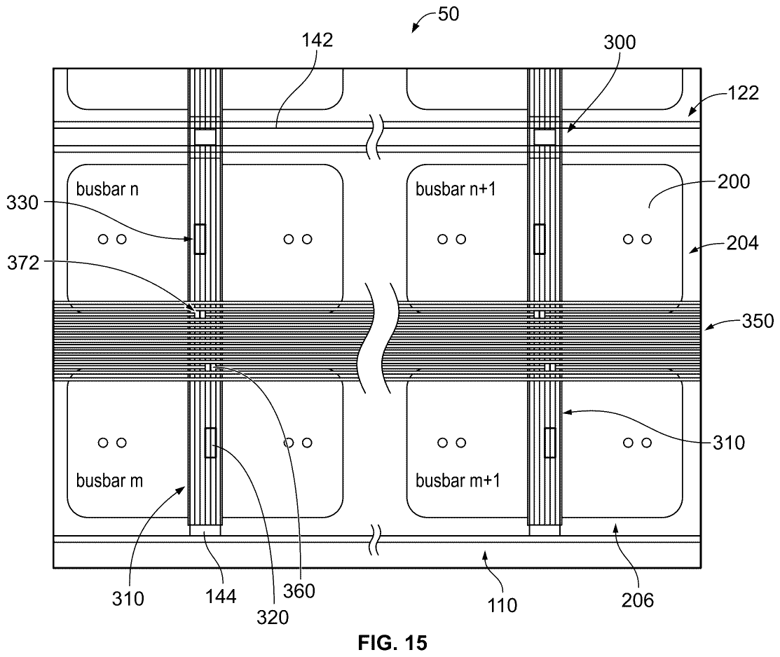

FIG. 14 is an enlarged view of a portion of the battery pack interconnect assembly 50 in accordance with an exemplary embodiment showing four rows 204 and two columns 206 of the busbars 200. FIG. 15 is an enlarged view of a portion of the battery pack interconnect assembly 50 in accordance with an exemplary embodiment showing two rows 204 and two columns 206 of the busbars 200. The sensing harness 300 traverses the rows 204 and columns 206 of the busbars 200 to electrically connect to each of the busbars 200 for sensing characteristics (for example, voltages) of each of the busbars 200.

When assembled, the sensing harness 300 is coupled to the busbars 200. The sensing harness 300 may be coupled to the busbar carrier 110, such as to the frame members 122. For example, the busbar sensing cables 310 may be coupled to the longitudinal elements 142 and/or the lateral elements 144. The connecting cables 350 may be coupled to the longitudinal elements 142 and/or the lateral elements 144.

During assembly, the exposed portions of the sensing flat conductors 320 of the busbar sensing cables 310 at the sensing access windows 330 are electrically connected to the corresponding busbars 200. The sensing flat conductors 320 may be electrically connected to the corresponding busbars 200 by one of a welded connection, a conductive bonding connection, a staking connection, or a conductive adhesive connection. In an exemplary embodiment, multiple sensing flat conductors 320 are exposed in each of the sensing access windows 330 to allow multiple points of contact with each busbar 200 and form redundant electrical connections to the corresponding busbar 200 to improve reliability.

During assembly, the connecting flat conductors 360 are electrically connected to the sensing flat conductors 320 at the corresponding joining points. For example, the connecting access windows 332, 372 expose the sensing flat conductors 320 and the connecting flat conductors 360 for electrical connection therebetween. The connecting flat conductors 360 may be electrically connected to the corresponding sensing flat conductors 320 by one of a welded connection, a conductive bonding connection, a staking connection, or a conductive adhesive connection. The connecting access windows 374 expose different connecting flat conductors 360 along different segments of the connecting cable 350 for connection to different busbar sensing cables 310.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus—function format and are not intended to be interpreted based on 35 U.S.C. § 112(f), unless and until such claim limitations expressly use the phrase “means for” followed by a statement of function void of further structure.

What is claimed is:

1. A battery pack interconnect assembly for electrically connecting cell terminals of battery cells in a battery pack, the battery pack interconnect assembly comprising:
a busbar interconnect including a plurality of busbars arranged in a matrix having multiple rows of the busbars and multiple columns of the busbars and a busbar carrier holding the busbars, each busbar including a first mating end for mating with the corresponding cell terminal of the corresponding battery cell and a second mating end for mating with the adjacent cell terminal of the adjacent corresponding battery cell, the busbars electrically connecting the battery cells in the battery pack; and
a sensing harness having sensing points coupled to the busbars, the sensing harness including busbar sensing cables and connecting cables coupled to each of the busbar sensing cables, the busbar sensing cables being flat flexible cables having a plurality of sensing flat conductors, the connecting cables being flat flexible cables having a plurality of connecting flat conductors, the busbar sensing cables extending along the columns of the busbars with the sensing flat conductors electrically connected to the corresponding busbars in the corresponding column at the corresponding sensing points to sense a voltage of each of the corresponding busbars, the connecting cables spanning each of the busbar sensing cables with the connecting flat conductors electrically connected to the corresponding sensing flat conductors of each of the busbar sensing cables, the connecting flat conductors of the connecting cables electrically connected to a control module.

2. The battery pack interconnect assembly of claim 1, wherein the busbar sensing cables and the connecting cables form a lattice structure.

3. The battery pack interconnect assembly of claim 1, wherein the busbar sensing cables include sensing access windows exposing the corresponding sensing flat conductors at the sensing points.

4. The battery pack interconnect assembly of claim 1, wherein the sensing flat conductors are electrically connected to the corresponding busbars by one of a welded connection, a conductive bonding connection, a staking connection, or a conductive adhesive connection.

5. The battery pack interconnect assembly of claim 1, wherein the busbar sensing cables include first connecting access windows exposing the corresponding sensing flat conductors at joining points, the connecting the cables including second connecting access windows exposing the connecting flat conductors at joining points, the second connecting access windows being aligned with the corresponding first connecting access windows to electrically connect the connecting flat conductors with the corresponding sensing flat conductors at the joining points.

6. The battery pack interconnect assembly of claim 5, wherein the second connecting access windows expose different connecting flat conductors at each of the corresponding busbar sensing cables.

7. The battery pack interconnect assembly of claim 5, wherein the connecting flat conductors are electrically connected to the corresponding sensing flat conductors by one of a welded connection, a conductive bonding connection, a staking connection, or a conductive adhesive connection.

8. The battery pack interconnect assembly of claim 1, wherein the busbar sensing cables include conductor separating windows through the busbar sensing cables separating the sensing flat conductors into electrically isolated segments.

9. The battery pack interconnect assembly of claim 1, wherein multiple sensing flat conductors are connected to each busbar to define multiple points of contact between the busbar sensing cables and the corresponding busbars.

10. The battery pack interconnect assembly of claim 1, wherein the sensing harness includes electrical connectors at ends of the connecting cables, the electrical connectors being coupled to the control module.

11. The battery pack interconnect assembly of claim 1, wherein the busbar carrier includes frames coupled to the busbars to hold the busbars in the columns, the busbar sensing cables being coupled to the frames.

12. A sensing harness for sensing voltages of busbars electrically connected to cell terminals of battery cells in a battery pack, the sensing harness comprising:
busbar sensing cables extending parallel to each other in columns, the busbar sensing cables being flat flexible cables having a plurality of sensing flat conductors, the busbar sensing cables extending along columns of the busbars, the sensing flat conductors configured to be electrically connected to the corresponding busbars in the corresponding column at sensing points to sense a voltage of each of the corresponding busbars; and
connecting cables extending parallel to each other in rows, the connecting cables being flat flexible cables having a plurality of connecting flat conductors, the connecting cables spanning each of the busbar sensing cables, the connecting flat conductors being electrically connected to the corresponding sensing flat conductors of each of the busbar sensing cables, the connecting flat conductors of the connecting cables electrically connected to a control module.

13. The sensing harness of claim 12, wherein the busbar sensing cables and the connecting cables form a lattice structure.

14. The sensing harness of claim 12, wherein the busbar sensing cables include sensing access windows exposing the corresponding sensing flat conductors at the sensing points.

15. The sensing harness of claim 12, wherein the busbar sensing cables include first connecting access windows exposing the corresponding sensing flat conductors at joining points, the connecting the cables including second connecting access windows exposing the connecting flat conductors at joining points, the second connecting access windows being aligned with the corresponding first connecting access windows to electrically connect the connecting flat conductors with the corresponding sensing flat conductors at the joining points.

16. The sensing harness of claim 15, wherein the second connecting access windows expose different connecting flat conductors at each of the corresponding busbar sensing cables.

17. The sensing harness of claim 15, wherein the connecting flat conductors are electrically connected to the corresponding sensing flat conductors by one of a welded connection, a conductive bonding connection, a staking connection, or a conductive adhesive connection.

18. The sensing harness of claim 12, wherein multiple sensing flat conductors are configured to be connected to each busbar to define multiple points of contact between the busbar sensing cables and the corresponding busbars.

19. A battery pack comprising:
battery cells arranged in a matrix having multiple rows and multiple columns of the battery cells, each battery cell including a first cell terminal and a second cell terminal; and
a battery pack interconnect assembly electrically connected to the first and second cell terminals of the battery cells, the battery pack interconnect assembly including a busbar interconnect and a sensing harness electrically connected to the busbar interconnect;
the busbar interconnect including a plurality of busbars arranged in a matrix having multiple rows of the busbars and multiple columns of the busbars and a busbar carrier holding the busbars, each busbar including a first mating end for mating with the first cell terminal of the corresponding battery cell and a second mating end for mating with the second cell terminal of the adjacent corresponding battery cell, the busbars electrically connecting the battery cells in the battery pack;
the sensing harness having sensing points coupled to the busbars, the sensing harness including busbar sensing cables and connecting cables, the busbar sensing cables being flat flexible cables having a plurality of sensing flat conductors, the connecting cables being flat flexible cables having a plurality of connecting flat conductors, the busbar sensing cables extending along the columns of the busbars with the sensing flat conductors electrically connected to the corresponding busbars in the corresponding column at the corresponding sensing points to sense a voltage of each of the corresponding busbars, the connecting cables spanning each of the busbar sensing cables with the connecting flat conductors electrically connected to the corresponding sensing flat conductors of each of the busbar sensing cables, the connecting flat conductors of the connecting cables electrically connected to a control module.

20. The battery pack of claim 19, wherein multiple sensing flat conductors are connected to each busbar to define multiple points of contact between the busbar sensing cables and the corresponding busbars.
